(19) United States
(12) Patent Application Publication
(10) Pub. No.: US 2025/0322773 A1
(43) Pub. Date: Oct. 16, 2025

(54) Chip-Based RFID-Enabled Liner Free Labels and Rolls of Liner Free Labels

(71) Applicant: Iconex LLC, Duluth, GA (US)

(72) Inventor: Robert Epler, Morristown, TN (US)

(21) Appl. No.: 19/169,860

(22) Filed: Apr. 3, 2025

Related U.S. Application Data
(60) Provisional application No. 63/632,876, filed on Apr. 11, 2024.

(51) Int. Cl. G09F 3/00; G09F 3/02; G09F 3/10; H01Q 1/22

(52) U.S. Cl. CPC G09F 3/0297; G09F 3/10; H01Q 1/2208; G09F 2003/0269

(57) ABSTRACT

A liner free label includes a substrate having first and second sides, a radio frequency identification (RFID) inlay on the substrate which includes a chip and an antenna, and an adhesive applied to at least a portion of the first or second side. The RFID inlay may be embedded within the adhesive, function as a sense mark, or be accompanied by a separate sense mark. The antenna may comprise a printed antenna, foil antenna, or a combination thereof. The RFID inlay may be purchased from an original equipment manufacturer (OEM) or include an OEM chip with a separately manufactured antenna. A roll of liner free labels includes multiple such labels with adhesive applied as a flood coating, discontinuous patches, continuous patches, or patterns. The labels may be separated by perforations. The technology combines the waste reduction benefits of liner free labels with the tracking capabilities of RFID technology.

### RELATED APPLICATIONS

The present application is a non-provisional application of provisional Application No. 63/632,876 entitled “Chip and Chipless RFID-Enabled Liner Free Labels and Rolls of Linerless Labels” filed on Apr. 11, 2024, the disclosure of which is incorporated by reference in its entirety herein.

### BACKGROUND

Radio Frequency Identification (RFID) technology has revolutionized inventory management, supply chain logistics, and retail applications by enabling contactless identification and tracking of items. Traditional RFID labels typically include a liner that must be removed before application, creating waste and inefficiency in high-volume labeling operations. Linerless labels have emerged as an environmentally friendly label that eliminates the need for a disposable backing material, reducing waste and allowing for more labels per roll.

### BRIEF DESCRIPTION OF THE DRAWINGS

FIG. 1 is a diagram illustrating a method of making or assembling a chip-based radio frequency identification (RFID) liner free label and roll of labels, according to an example embodiment.

FIG. 2 is a diagram illustrating a roll of RFID chip-based liner free labels with adhesive patches or patterns, RFID inlays, sense marks, and/or no sense marks, according to an example embodiment.

FIG. 3 is a diagram illustrating a roll of RFID chip-based liner free labels with adhesive patches or patterns and combined RFID inlays and sense marks, according to an example embodiment.

FIG. 4 is a diagram illustrating a roll of RFID chip-based liner free labels with flood coated adhesive and RFID inlays with no sense marks, according to an example embodiment.

### DETAILED DESCRIPTION

As used herein, the term and phrase “linerless” and/or “liner free” may be used interchangeably and synonymously.

The present disclosure relates to chip-based radio frequency identification (RFID) liner free labels and rolls of liner free labels. The embodiments described herein provide various approaches for incorporating RFID inlays with chips and antennas onto liner free labels, which offer advantages in terms of waste reduction and increased label capacity per roll while maintaining the benefits of RFID technology for tracking and identification purposes.

The integration of RFID technology with linerless labels presents unique technical challenges that the present disclosure addresses. By eliminating the liner while maintaining RFID functionality, the disclosed technology provides environmental benefits, cost savings, and improved efficiency in labeling operations.

The RFID inlays described herein operate in various frequency ranges, including but not limited to high frequency (HF) at 13.56 MHz, ultra-high frequency (UHF) at 860-960 MHz, and near-field communication (NFC) at 13.56 MHz, enabling different read ranges and data transfer capabilities depending on the specific application requirements. HF and NFC inlays typically provide read ranges of a few centimeters and are suitable for applications requiring close proximity reading, while UHF inlays can provide read ranges of several meters, making them ideal for inventory tracking and supply chain applications. The specific frequency range selection impacts the size and design of the antenna, with UHF antennas generally being larger than HF antennas to achieve optimal performance when integrated with the liner free label structure.

The RFID chips in these inlays can store varying amounts of data depending on the specific chip model, ranging from basic identification numbers to more complex product information, manufacturing data, or tracking history. This data storage capability enables advanced inventory management and product authentication beyond what is possible with traditional barcode technology.

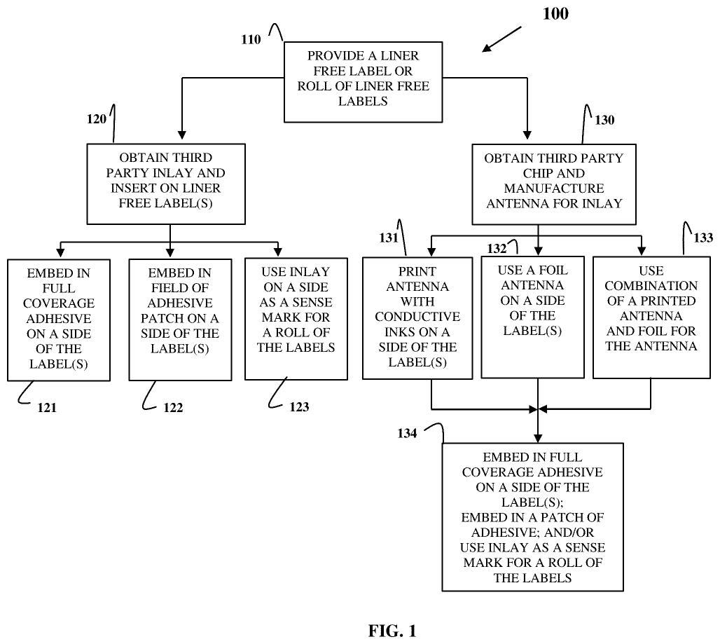

FIG. 1 illustrates a method 100 of making or assembling a chip-based RFID liner free label or roll of liner free labels. The method illustrates two options for making a liner free label with an RFID inlay. The first option is illustrated at 120 and the second option is illustrated at 130.

At 110, the method 100 begins with obtaining or providing a liner free label or roll of liner free labels. An RFID inlay (e.g., RFID chip and RFID antenna) is then obtained for insertion on the label or roll of labels. This can be accomplished through two main approaches: obtaining a third-party inlay and inserting it on the liner free label(s) at 120 or obtaining a third-party chip and manufacturing an antenna for the inlay at 130.

When obtaining a third-party inlay at 120, the inlay may be embedded in full coverage adhesive applied or deposited on a portion of a side or all of a side of the label(s) at 121 or embedded in a field of an adhesive patch on a side of the label(s) at 122. In either case, the third-party inlay may be used as a sense mark for a roll of the labels 123.

When obtaining a third-party chip and manufacturing an antenna at 130, the antenna may be printed with conductive inks on a side of the label(s) at 131, implemented as a foil antenna on a side of the label(s) at 132, or created using a combination of a printed antenna and foil for the antenna at 133. After manufacturing the antenna, the inlay may be embedded in full coverage adhesive on a side of the label(s), embedded in a patch of adhesive, or embedded in a patch pattern of adhesive at 134. The inlay may also be used as a sense mark for a roll of the labels at 134.

In an embodiment, when obtaining a third-party inlay at 120, the inlay may be purchased from an original equipment manufacturer (OEM) and directly integrated onto the liner free label. This approach typically represents the quickest implementation path, though it may have higher associated costs compared to manufacturing custom antennas. The third-party inlay includes both the chip and antenna components pre-assembled and ready for integration.

In an embodiment, when obtaining a third-party chip and manufacturing an antenna at 130, the chip is purchased from an OEM while the antenna is custom manufactured. This approach provides greater flexibility in antenna design and potentially reduces costs compared to purchasing complete inlays. The antenna may be printed directly onto the label substrate using conductive inks at 131, which allows for precise integration with the label structure. Alternatively, the antenna may be created using foil at 132, which can provide enhanced conductivity properties. A third option combines both printed elements and foil components at 133 to optimize performance characteristics of the antenna.

In an embodiment, method 100 enables selection of the most appropriate implementation approach based on cost considerations, implementation timeline requirements, and desired performance characteristics. The full coverage adhesive embedding approach at 121 and 134 provides uniform adhesion across the label surface, while the adhesive patch approach at 122 allows for strategic placement of adhesive only where needed. Using the RFID inlay as a sense mark at 123 and 134 reduces the need for additional printing while maintaining compatibility with automated label dispensing systems.

In an embodiment, the adhesive used for the labels include permanent adhesives, removable adhesives, repositionable adhesives, water-based repositionable adhesives, solvent-based repositionable adhesives, freezer or cold-temperature adhesives, high-tack adhesives, low-tack or ultra-removable adhesives, water-based adhesives, hot melt adhesives, solvent-based adhesives, silicone-based adhesives, ultraviolet (UV)-curable adhesives, or mixtures of one or more of the recited adhesives. In an embodiment, the permanent adhesives include rubber-based adhesives and/or acrylic adhesives. In an embodiment, the removable adhesives include rubber-based removable adhesives, acrylic-based removable adhesives, microsphere adhesives, silicone-based removable adhesives, water-based repositionable adhesives, and/or hot melt removable adhesives. In an embodiment, the adhesive may be applied in a single layer or in a combination of layers as adhesive bumps atop one another.

In an embodiment, sense marks are printed on the backside of the substrate to delineate between individual labels within the roll. In an embodiment, the antenna serves as a sense mark on the backside of the individual labels of the roll. In an embodiment, the inlay serves as a sense mark on the backside of the roll. In an embodiment, the roll of liner free labels does not include any sense marks.

In an embodiment, a side or a front side of the single substrate used for the roll of liner free labels includes a release coating deposited over a thermally activated print coating. This permits the single substrate to be wound into a roll with the front side released from the backside adhesive when being unwound by a printer. The release coating may include a water-based release coating, a silicone-based release coating, a UV-cured silicone release coating, a fluoropolymer-based release coating, a non-silicone release coating, a mixture of water-based and silicone-based release coating, a solvent-based chemistry release coating, and other release coatings.

In an embodiment, the substrate is a film. In an embodiment, the substrate is paper-based material.

In an embodiment, the RFID chip-based liner free labels described herein are designed to be compatible with existing thermal printers, existing automated label applicators, and existing RFID encoders while providing enhanced label and package tracking capabilities. In an embodiment, the RFID chip-based liner free labels may necessitate minimal modifications to existing equipment associated with existing thermal printers, existing automated label applications, and/or existing RFID encodes while providing enhanced tracking label and package capabilities.

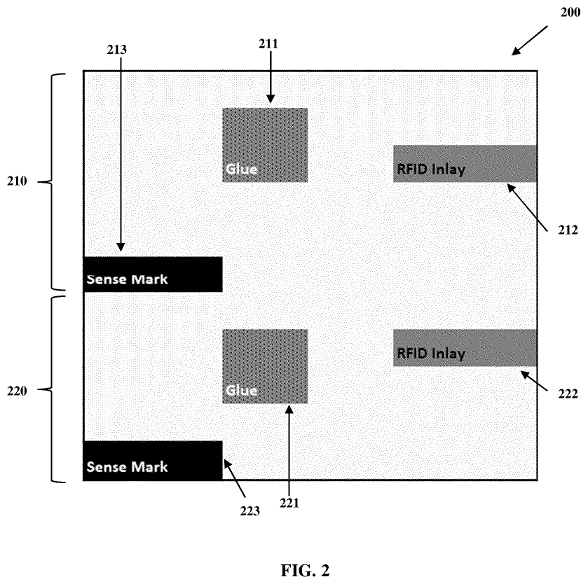

FIGS. 2-4 illustrate specific embodiments of rolls of RFID chip-based liner free labels implementing the approaches described in FIG. 1. These embodiments demonstrate different configurations of adhesive application, RFID inlay placement, and sense mark implementation that may be selected based on specific application requirements, manufacturing considerations, and cost factors.

FIG. 2 is a diagram illustrating a roll 200 of RFID chip-based liner free labels 210 and 220 with adhesive flood coatings (e.g., full coverage, flood coated adhesive, etc.), adhesive patches, adhesive stripes, or adhesive patch patterns 211 and 221, RFID inlays 212 and 222, sense marks 213 and 223, and/or no sense marks, according to an example embodiment. Roll 200 of liner free labels 210 and 220 are shown in simplified form with only those components necessary for understanding the embodiment presented and described. It is noted that other components can be present such as one or more release coatings, print coatings, primer coatings, or other coatings. Moreover, FIG. 2 illustrates the backside of the roll 200 or substrate 200. The front side includes a variety of coatings such as thermal coatings, laser print coatings, inkjet print coatings, ink coatings, direct thermal print coatings, thermal transfer print coatings, release coatings, and/or primer coatings, etc.

The roll 200 includes a single substrate 200, the backside of the roll/substrate 200 includes RFID inlays 212 and 222 for each separately defined label 210 and 220 within the roll/substrate 200. In an embodiment, the inlays 212 and 222 are integrated onto the backside. In an embodiment, the inlays 212 and 222 are existing RFID inlays manufactured by third parties and integrated onto the backside of the roll/substrate 200.

The backside of the roll/substrate 200 also includes one or more adhesive areas 211 and 221. The adhesive areas 211 and 221 are discontinuously disposed on the backside with areas free of adhesive therebetween.

In an embodiment, the adhesive areas 211 and 221 are adhesive patches. In an embodiment, the adhesive areas 211 and 221 are flood coated on the backside of the roll/substrate 200.

In an embodiment, each adhesive patch includes a pattern of adhesive patches. In an embodiment, the adhesive is a repositionable adhesive, such as a microsphere adhesive. In an embodiment, the adhesive is a permanent adhesive, such as a hot melt or acrylic adhesive, which may be formulated to be a repositionable adhesive. In an embodiment, the adhesive is a combination of different adhesive types or a mixture of adhesives. In an embodiment, the adhesive is disposed in a single layer. In an embodiment, the adhesive is disposed on the backside in two or more layers creating adhesive bumps within the adhesive areas 211 and 221.

In an embodiment, the backside of the roll/substrate 200 further includes printed sense marks 213 and 223. The sense marks permit a printer's optical sensor to identify a given sense mark and cut a given label from the roll/substrate 200 after the given label is imaged with custom indicia. The sense marks 213 and 223 delineate between individual labels 210 and 220 within the roll/substrate 200.

In an embodiment, the backside of the roll/substrate 200 includes no sense marks.

In an embodiment, the front side of the roll/substrate 200 includes a print coating, such as a thermal transfer coating, a direct thermal coating, an inkjet coating, an ink coating, a dot matrix coating, and/or a laser coating. Overtop of the print coating is a release coating. The release coating may be a water-based release coating, a silicone-based release coating, a mixture of water-based and silicone-based release coating, a solvent-based chemistry release coating, and other release coatings.

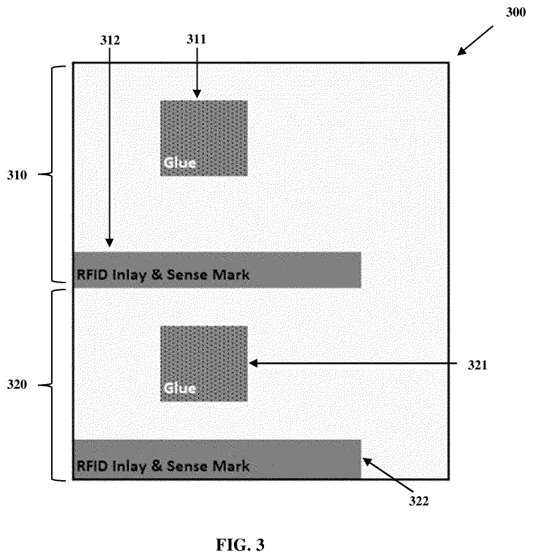

FIG. 3 is a diagram illustrating a roll 300 of RFID chip-based liner free labels 310 and 320 with adhesive patches or patterns 311 and 321 and combined RFID inlays and sense marks 312 and 322, according to an example embodiment. The roll 300 of liner free labels 310 and 320 are shown in simplified form with only those components necessary for understanding the embodiment presented and described. It is noted that other components can be present such as one or more release coatings, print coatings, primer coatings, or other coatings. Moreover, FIG. 3 illustrates the backside of the roll 300 or substrate 300. The front side includes a variety of coatings such as thermal coatings, laser print coatings, inkjet print coatings, ink coatings, direct thermal print coatings, thermal transfer print coatings, release coatings, and/or primer coatings, etc.

The roll 300 includes a single substrate 300, the backside of the roll/substrate 300 includes RFID inlays 312 and 322 for each separately defined label 310 and 320 within the roll/substrate 300. In an embodiment, the inlays 312 and 322 are integrated onto the backside. In an embodiment, the inlays 312 and 322 are existing RFID inlays manufactured by third parties and integrated onto the backside of the roll/substrate 300.

The inlays 312 and 322 may also functionally serve as sense marks on the backside of the roll/substrate 300. That is, a printer is enhanced to detect the inlays 312 and 322 and force a delay for a configured number of microsecond/milliseconds before stopping the roll 300 from advancing and cutting an individual label 310 or 320 from the roll 300. This avoids cutting through the inlays 312 and 322 and ensures that the printer cuts an individual label from the roll after the corresponding inlay 312 or 322 but before the adhesive area 311 or 321 of the next label. The locations of the inlays 312 and 322 are in a location of the backside of the roll 300 that a conventional sense mark would be printed on the backside.

Using the RFID inlay as a sense mark provides technical advantages over conventional printed sense marks, including reduced manufacturing steps, improved durability since no printed mark can wear off, and enhanced detection reliability through the electromagnetic signature of the inlay rather than relying solely on optical detection.

In an embodiment, the front side of the roll/substrate 300 includes a print coating, such as a thermal transfer coating, a direct thermal coating, an inkjet coating, ink coatings, a dot matrix coating, and/or a laser coating. Overtop of the print coating is a release coating. The release coating may be a water-based release coating, a silicone-based release coating, a mixture of water-based and silicone-based release coating, a solvent-based chemistry release coating, and other release coatings.

The backside of the roll/substrate 300 also includes one or more adhesive areas 311 and 321. In an embodiment, the adhesive areas 311 and 321 are flood coated on a side of the roll/substrate 300. In an embodiment, the adhesive areas 311 and 321 are discontinuously disposed on the backside with areas free of adhesive therebetween. In an embodiment, the adhesive areas are continuous adhesive patches or stripes on the backside with areas of free of adhesive or adhesive free therebetween. In an embodiment, the adhesive areas 311 and 321 are adhesive patches. In an embodiment, each adhesive patch includes a pattern of adhesive patches. In an embodiment, the adhesive is a repositionable adhesive, such as a microsphere adhesive. In an embodiment, the adhesive is a permanent repositionable adhesive, such as a hot melt or acrylic adhesive, which may be formulated to be a repositionable adhesive. In an embodiment, the adhesive is a combination of different adhesive types or a mixture of adhesives. In an embodiment, the adhesive is disposed in a single layer. In an embodiment, the adhesive is disposed on the backside in two or more layers creating adhesive bumps within the adhesive areas 311 and 321.

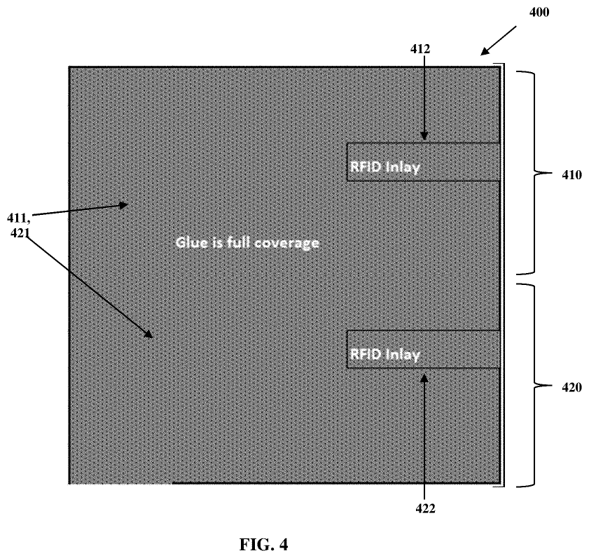

FIG. 4 is a diagram illustrating a roll 400 of RFID chip-based liner free labels 410 and 420 with flood coated adhesive 411 and 421 and RFID inlays 412 and 422 with no sense marks, according to an example embodiment. The roll 400 of liner free labels 410 and 420 are shown in simplified form with only those components necessary for understanding the embodiment presented and described. It is noted that other components can be present such as a release coatings, print coatings, primer coatings, or other coatings. Moreover, FIG. 4 illustrates the backside of the roll 400 or substrate 400. The front side includes a variety of coatings such as thermal coatings, laser print coatings, inkjet print coatings, ink coatings, direct thermal print coatings, thermal transfer print coatings, one or more release coatings, and/or primer coatings, etc.

The roll 400 includes a single substrate 400, the backside of the roll/substrate 400 includes RFID inlays 412 and 422 for each separately defined label 410 and 420 within the roll/substrate 400. In an embodiment, the inlays 412 and 422 are integrated onto the backside. In an embodiment, the inlays 412 and 422 are existing RFID inlays manufactured by third parties and integrated onto the backside of the roll/substrate 400.

The backside of the roll/substrate 400 includes no sense marks. In an embodiment, the printer is configured to avoid cutting through the inlays 412 and 422.

In an embodiment, the backside of the roll/substrate 400 is flood coated with adhesive 411 and 421. In an embodiment, the left side and right side of the backside of the roll/substrate 400 includes adhesive free zones that are free of adhesive. In an embodiment, the left side, right side, top side, and bottom side of the backside of the roll/substrate 400 includes adhesive free zones that are free of adhesive. In an embodiment, the adhesive is a repositionable adhesive, such as a microsphere adhesive. In an embodiment, the adhesive is a reasonably permanent adhesive, such as a hot melt or acrylic adhesive, which may be formulated to also be repositionable. In an embodiment, the adhesive is a combination of different adhesive types or a mixture of adhesives. In an embodiment, the adhesive is disposed in a single layer. In an embodiment, the adhesive is disposed on the backside in two or more layers creating adhesive bumps within the adhesive areas 411 and 421.

In an embodiment, the front side of the roll/substrate 400 includes a print coating, such as a thermal transfer coating, a direct thermal coating, an inkjet coating, an ink coating, a dot matrix coating, and/or a laser coating. Overtop of the print coating is a release coating. The release coating may be a water-based release coating, a silicone-based release coating, a mixture of water-based and silicone-based release coating, a solvent-based chemistry release coating, and other release coatings.

In an embodiment, adjacent liner free labels in the roll 400 are separated by perforations.

Although the present invention is described with reference to certain preferred embodiments thereof, variations and modifications of the present invention can be affected within the spirit and scope of the following claims.

1. A liner free label, comprising:
a substrate having a first side and a second side;
a radio frequency identification (RFID) inlay on the substrate, wherein the RFID inlay comprises a chip and an antenna; and
an adhesive applied to a portion of the first side or the second side.

2. The liner free label of claim 1, wherein the adhesive is applied in a pattern on the first side of the substrate.

3. The liner free label of claim 1, wherein the adhesive is applied as a full coverage layer on the first side or the second side of the substrate.

4. The liner free label of claim 1, further comprises one of:
a sense mark on the first side or the second side of the substrate; or
no sense mark on either the first side or the second side of the substrate.

5. The liner free label of claim 4, wherein the RFID inlay is configured to be the sense mark.

6. The liner free label of claim 1, wherein the RFID inlay is embedded under flood coated adhesive or patched adhesive on the first side or the second side of the substrate.

7. The liner free label of claim 1, wherein the antenna comprises a printed antenna.

8. The liner free label of claim 1, wherein the antenna comprises a foil antenna.

9. The liner free label of claim 1, wherein the antenna comprises a combination of a printed antenna and a foil antenna.

10. The liner free label of claim 1, wherein the RFID inlay is obtained from an original equipment manufacturer (OEM) and inserted on the liner free label.

11. The liner free label of claim 1, wherein the chip is an original equipment manufacturer (OEM) chip and the antenna is manufactured separately and integrated with the chip on the liner free label.

12. A roll of liner free labels comprising:
a plurality of liner free labels comprising:
a substrate having a first side and a second side;
a radio frequency identification (RFID) inlay on the substrate, wherein the RFID inlay comprises a chip and an antenna; and
an adhesive applied to a portion of the first side or the second side of the substrate.

13. The roll of liner free labels of claim 12, wherein the adhesive is applied as one or more discontinuous adhesive patches or stripes on the first side or the second side of each substrate.

14. The roll of liner free labels of claim 12, wherein the adhesive is applied as one or more continuous adhesive patches on the first side or the second side of each substrate.

15. The roll of liner free labels of claim 12, wherein the adhesive is applied in patch patterns on the first side or the second side of each substrate.

16. The roll of liner free labels of claim 12, further comprising a particular RFID inlay that serves as a sense mark on the first side or the second side of each substrate.

17. The roll of liner free labels of claim 12, wherein adjacent liner free labels in the roll are separated by perforations.

18. The roll of liner free labels of claim 12, wherein the RFID inlay of each liner free label is embedded within the adhesive on the first side or the second side of the substrate.

19. A label comprising:
a substrate; and
a radio frequency identification (RFID) inlay, wherein the RFID inlay comprises a chip and an antenna; and
wherein the label is configured to be applied to a surface without a liner.

20. The label of claim 19, wherein the RFID inlay is embedded within an adhesive layer on the substrate.
